(19) United States
(12) Patent Application Publication
(10) Pub. No.: US 2024/0151311 A1
(43) Pub. Date: May 9, 2024

(54) BUTTERFLY VALVE AND HEAT EXHANGER

(71) Applicant: NGK INSULATORS, LTD., Nagoya-City (JP)

(72) Inventors: Ryushiro AKAISHI, Nagoya-Shi (JP); Tatsuo KAWAGUCHI, Mizuho-Shi (JP); Hiroshi MIZUNO, Kakamigahara-Shi (JP); Fumitaka TAKEUCHI, Kasugai-Shi (JP); Shinnosuke IWASAKI, Komaki-Shi (JP); Yui HONDA KURIMOTO, Nagoya-Shi (JP)

(73) Assignee: NGK INSULATORS, LTD., Nagoya-City (JP)

(21) Appl. No.: 18/464,318

(22) Filed: Sep. 11, 2023

(30) Foreign Application Priority Data
Nov. 7, 2022 (JP) 2022-178399

(51) Int. Cl. F16K 1/226; F28D 7/10; F28F 27/00

(52) U.S. Cl. CPC F16K 1/2261; F28D 7/106; F28F 27/00

(57) ABSTRACT

A butterfly valve 100 provided in a flow path for a first fluid flowing through a heat exchanger. The butterfly valve 100 includes: a valve plate 110 provided in the flow path; a shaft 120 for rotatably supporting the valve plate 110 in the flow path; and at least one valve plate auxiliary member 130 in contact with at least one plate surface 111a, 111b of the valve plate 100, the valve plate auxiliary member 130 having an extending portion 131 extending radially outwardly from an outer peripheral surface 112 of the valve plate 110. The valve plate auxiliary member 130 is made of a material having a lower Young's modulus than that of the valve plate 110.

### CROSS REFERENCE TO RELATED APPLICATIONS

The present invention claims the benefit of priority to Japanese Patent Application No 2022-178399 filed on Nov. 7, 2022 with the Japanese Patent Office, the entire contents of which are incorporated herein by reference in its entirety.

### FIELD OF THE INVENTION

The present invention relates to a butterfly valve and a heat exchanger.

### BACKGROUND OF THE INVENTION

Recently, there is a need for improvement of fuel economy of motor vehicles. In particular, a system is expected that worms up a coolant, engine oil and an automatic transmission fluid (ATF: Automatic Transmission Fluid) at an early stage to reduce friction losses, in order to prevent deterioration of fuel economy at the time when an engine is cold, such as when the engine is started. Further, a system is expected that heats an exhaust gas purifying catalyst in order to activate the catalyst at an early stage.

As one of such systems, for example, there is a heat exchanger. The heat exchanger is a device that exchanges heat between a first fluid and a second fluid by allowing the first fluid to flow inside and the second fluid to flow outside. In such a heat exchanger, for example, the heat can be effectively utilized by exchanging the heat from the first fluid having a higher temperature (for example, an exhaust gas) to the second fluid having a lower temperature (for example, cooling water).

As a heat exchanger for recovering heat from high-temperature gases such as exhaust gases from motor vehicles, Patent Literature 1 proposes a heat exchanger (exhaust heat recovering device) including: a branched portion for splitting an introduced exhaust gas into two parts; a first flow path extending from the branched portion; a second flow path extending from the branched portion along the first flow path; a heat recovery portion for transferring heat from the exhaust gas to a medium, the heat recovery portion being attached to the second flow path; and a valve rotatably attached to a downstream end portion of the first flow path to open and close the first flow path. The valve has a function of switching the exhaust gas flow to the first or second flow path. This can lead to, for example, switching between a mode where the heat is recovered during warming-up and a mode where the heat is not recovered after warming-up is complete. However, there is a limit to make this heat exchanger compact, because the heat exchanger forms the first and second flow paths by branching the piping into two parts and also uses a flap valve as the valve.

Therefore, from the viewpoint of making the heat exchanger compact, a heat exchanger using a hollow pillar shaped honeycomb structure has been proposed. For example, Patent Literature 2 discloses a heat exchanger including: a hollow pillar shaped honeycomb structure having a partition wall, an inner peripheral wall, and an outer peripheral wall, the partition wall defining a plurality of cells each forming a flow path for a first fluid, the flow path extending from an inflow end face to an outflow end face; a first outer cylinder arranged so as to be in contact with the outer peripheral wall of the pillar shaped honeycomb structure; a first inner cylinder having an inflow port and an outflow port for the first fluid, the first inner cylinder being arranged such that a part of an outer peripheral surface of the first cylinder is in contact with an inner peripheral wall of the pillar shaped honeycomb structure; a second inner cylinder having an inflow port and an outflow port for the first fluid, the outflow port being arranged radially inward of the inner peripheral wall of the pillar shaped honeycomb structure with a space therebetween; and an on-off valve arranged on the outflow port side of the first inner cylinder. As the valve, a butterfly valve is used from the viewpoint of making the heat exchanger compact.

### PRIOR ART

### Patent Literatures

[Patent Literature 1] Japanese Patent No. 5912780 B
[Patent Literature 2] Japanese Patent Application Publication No. 2020-159270 A

### SUMMARY OF THE INVENTION

The present invention is exemplified as follows:

(1)

A butterfly valve provided in a flow path for a first fluid flowing through a heat exchanger, comprising:
a valve plate provided in the flow path;
a shaft for rotatably supporting the valve plate in the flow path; and
at least one valve plate auxiliary member in contact with at least one plate surface of the valve plate, the valve plate auxiliary member having an extending portion extending radially outwardly from an outer peripheral surface of the valve plate;
wherein the valve plate auxiliary member is made of a material having a lower Young's modulus than that of the valve plate.
   (2)

The butterfly valve according to (1), wherein the valve plate auxiliary member has a ring shape having an inner diameter smaller than an outer diameter of the valve plate, and having an outer diameter larger than the outer diameter of the valve plate and smaller than an inner diameter of the flow path.

(3)

The butterfly valve according to (2), wherein the valve plate auxiliary member has a halved ring shape wherein the ring shape is divided into halves.

(4)

The butterfly valve according to (3), wherein the halved ring shape has at least one notch formed on the inner diameter side.

(5)

The butterfly valve according to (1), wherein the valve plate auxiliary member comprises two or more valve plate auxiliary member pieces that are not in contact with each other.

(6)

The butterfly valve according to any one of (1) to (5), wherein, when the valve plate is divided into two regions A and B by a bisector passing through a central axis of the valve plate, the valve plate auxiliary member is in contact with one plate surface of the valve plate in the region A, and with the other plate surface of the valve plate in the region B.

(7)

The butterfly valve according to any one of (1) to (6), wherein the valve plate has at least one groove portion on an outer peripheral surface of the valve plate, and at least a part of the valve plate auxiliary member is arranged in the groove portion.

(8)

The butterfly valve according to any one of (1) to (7), wherein the valve plate has a three-layer structure wherein a third plate having a smaller diameter than a first plate and a second plate is sandwiched between the first plate and the second plate.

(9)

The butterfly valve according to (8), wherein the valve plate auxiliary member has a structure that is in contact with both plate surfaces and an outer peripheral surface(s) of the first plate and/or the second plate.

(10)

The butterfly valve according to any one of (1) to (6), wherein the valve plate comprises a first plate and a second plate, and at least a part of the valve plate auxiliary member is arranged between the first plate and the second plate.

(11)

The butterfly valve according to (10), wherein the valve plate auxiliary member has a structure that is contact with both plate surfaces and an outer peripheral surface(s) of the first plate and/or the second plate.

(12)

The butterfly valve according to any one of (1) to (11), wherein an inner peripheral portion of the flow path for the first fluid has at least one stopper portion contactable with the valve plate and/or the valve plate auxiliary member.

(13)

A heat exchanger comprising the butterfly valve according to any one of (1) to (12).

(14)

The heat exchanger according to (13), further comprising:
a hollow pillar shaped honeycomb structure having an outer peripheral wall, an inner peripheral wall, and a partition wall disposed between the outer peripheral wall and the inner peripheral wall, the partition wall defining a plurality of cells, each of the cells extending from a first end face to a second end face to form a flow path for a first fluid; and
an inner cylindrical member fitted to a surface of the inner peripheral wall of the pillar shaped honeycomb structure;
wherein the butterfly valve is provided on a downstream end portion side of the inner cylindrical member.
   (15)

The heat exchanger according to (14), further comprising:
a first outer cylindrical member fitted to a surface of the outer peripheral wall of the pillar shaped honeycomb structure;
an upstream cylindrical member having a portion arranged on a radially inner side of the inner cylindrical member at a distance so as to form a flow path for the first fluid;
a cylindrical connecting member for connecting an upstream end portion of the first outer cylindrical member to an upstream side of the inner cylindrical member;
a downstream cylindrical member connected to a downstream end portion of the first outer cylindrical member, the downstream cylindrical portion having a portion arranged on a radially outer side of the inner cylindrical member at a distance so as to form a flow path for the first fluid; and
a second outer cylindrical member arranged on a radially outer side of the first outer cylinder member at a space so as to form a flow path for a second fluid,
wherein the inner cylindrical member has at least one through hole through which the first fluid flowing through the flow path between the inner cylindrical member and the upstream cylindrical member can be introduced into the pillar shaped honeycomb structure.

### BRIEF DESCRIPTION OF THE DRAWINGS

FIG. 1 is a cross-sectional view of a butterfly valve provided in a flow path for a first fluid according to an embodiment of the present invention, which is parallel to a flow path direction of a first flow path;

FIG. 2 is a cross-sectional view taken along the line a-a′ in FIG. 1;

FIG. 3 is a cross-sectional view of a butterfly valve provided in a flow path for a first fluid according to another embodiment of the present invention, which is parallel to a flow path direction of a first flow path;

FIG. 4 is a cross-sectional view taken along the line e-e′ in FIG. 3;

FIG. 5 is a cross-sectional view of a butterfly valve provided in a flow path for a first fluid according to another embodiment of the present invention, which is parallel to a flow path direction of a first flow path;

FIG. 6 is a cross-sectional view taken along the line b-b′ in FIG. 5;

FIG. 7 is plane views of a valve plate, a valve plate auxiliary member, and a combination thereof, which are used for a butterfly valve according to another embodiment of the present invention;

FIG. 8 is a cross-sectional view of a butterfly valve provided in a flow path for a first fluid according to another embodiment of the present invention, which is perpendicular to a flow path direction of a first flow path;

FIG. 9 is a cross-sectional view of a butterfly valve provided in a flow path for a first fluid according to another embodiment of the present invention, which is parallel to a flow path direction of a first flow path;

FIG. 10 is a cross-sectional view taken along the line c-c′ in FIG. 9;

FIG. 11 is an example of shapes of valve plate auxiliary member pieces;

FIG. 12 is a cross-sectional view of a butterfly valve provided in a flow path for a first fluid according to another embodiment of the present invention, which is parallel to a flow path direction of a first flow path;

FIG. 13 is a cross-sectional view of a butterfly valve provided in a flow path for a first fluid according to another embodiment of the present invention, which is parallel to a flow path direction of a first flow path;

FIG. 14 is a cross-sectional view of a butterfly valve according to another embodiment of the present invention, which is parallel to a flow path direction of a first flow path;

FIG. 15 is a cross-sectional view of a butterfly valve according to another embodiment of the present invention, which is parallel to a flow path direction of a first flow path;

FIG. 16 is a cross-sectional view of a butterfly valve according to another embodiment of the present invention, which is parallel to a flow path direction of a first flow path;

FIG. 17 is a cross-sectional view of a butterfly valve provided in a flow path for a first fluid according to another embodiment of the present invention, which is parallel to a flow path direction of a first flow path;

FIG. 18 is a cross-sectional view of a heat exchanger according to an embodiment of the present invention, which is parallel to a flow path direction of a first fluid; and

FIG. 19 is a cross-sectional view taken along the line d-d′ in the heat exchanger in FIG. 18.

### DETAILED DESCRIPTION OF THE INVENTION

In the conventional heat exchangers using the butterfly valves, a difference between an inner diameter of a piping (the first inner cylinder in Patent Literature 2) in which a valve plate of the butterfly valve is disposed and an outer diameter of the valve plate (hereinafter the difference being referred to as “valve clearance”) must be large in order to prevent variations in production and thermal fixing due to exposure to an exhaust gas at high temperature and high flow rate. On the other hand, a larger valve clearance leads to insufficient blocking of the first fluid (exhaust gas) by the butterfly valve during heat recovery. As a result, the first fluid is not sufficiently fed to the heat recovery portion, resulting in poor heat recovery performance.

The present invention has been made to solve the above problems. An object of the present invention is to provide a butterfly valve capable of suppressing thermal fixing and improving blocking performance of the first fluid.

Another object of the present invention is to provide a heat exchanger having improved heat recovery performance.

As a result of intensive studies for a structure of a butterfly valve, the present inventors have found that the above problems can be solved by providing a valve plate auxiliary member having a specific extending portion made of a specific material at a specific position on the valve plate, and have completed the present invention.

According to the present invention, it is possible to provide a butterfly valve capable of suppressing thermal fixing and improving blocking performance of the first fluid.

Also, according to the present invention, it is possible to provide a heat exchanger having improved heat recovery performance.

A butterfly valve according to the present invention is provided in a flow path for a first fluid flowing through a heat exchanger, and includes: a valve plate provided in the flow path; a shaft for rotatably supporting the valve plate in the flow path; and at least one valve plate auxiliary member in contact with at least one plate surface of the valve plate, the valve plate auxiliary member having an extending portion extending radially outward from an outer peripheral surface of the valve plate. Also, the valve plate auxiliary member is made of a material having a lower Young's modulus than that of the valve plate. Such a structure allows the valve plate auxiliary member to be brought into contact with a member (e.g., a pipe) forming the flow path for the first fluid, which can prevent the valve plate from being thermally fixed to the member forming the flow path for the first fluid. Moreover, it allows a valve clearance to be increased, so that costs for producing the valve plate can be reduced. Further, when blocking the flow of the first fluid, the valve plate auxiliary member thermally expands toward the member forming the flow path for the first fluid together with the valve plate, thereby improving the blocking performance of the first fluid. Furthermore, the valve plate does not come into indirect contact with the member forming the flow path for the first fluid, so that quietness is improved during opening and closing of the butterfly valve.

Also, a heat exchanger according to an embodiment of the present invention includes the butterfly valve. Since the butterfly valve can improve the blocking performance of the exhaust gas while suppressing the thermal fixing, the heat recovery performance can be improved.

Hereinafter, embodiments of the heat exchanger of the present invention will be specifically described with reference to the drawings. It is to understand that the present invention is not limited to the following embodiments, and those which appropriately added changes, improvements and the like to the following embodiments based on knowledge of a person skilled in the art without departing from the spirit of the present invention fall within the scope of the present invention.

### (1. Butterfly Valve)

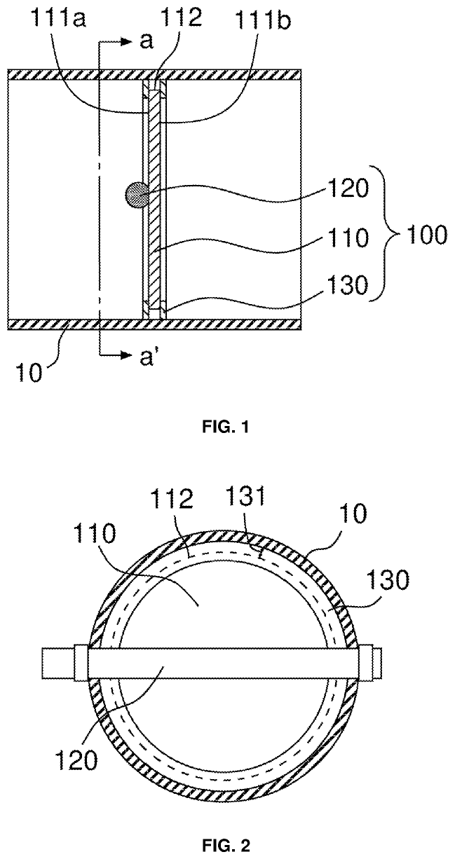

FIG. 1 is a cross-sectional view of a butterfly valve provided in a flow path for a first fluid according to an embodiment of the present invention, which is parallel to a flow path direction of a first flow path (which may be referred to as “a flow path for a first fluid in the specification). Also, FIG. 2 is a cross-sectional view taken along the line a-a′ in FIG. 1.

As shown in FIGS. 1 and 2, a butterfly valve 100 includes: a valve plate 110 provided inside a pipe 10 that is the flow path for the first fluid; a shaft 120 for rotatably supporting the valve plate 110 inside the pipe 10; at least one valve plate auxiliary member 130 having an extending portion 131 that is in contact with plate surfaces 111a, 111b of the valve plate 110 and extend toward a radially outer side than an outer peripheral surface 112 of the valve plate 110. It should be noted that although the butterfly valve 100 shown in FIGS. 1 and 2 shows an example in which two valve plate auxiliary members 130 are provided so as be in contact with both (two) of the plate surfaces 111a, 111b of the valve plate 110, respectively, one valve plate auxiliary member 130 may be provided so as to be in contact with one plate surface 111a or the plate surface 111b of the valve plate 110.

As used herein, the “plate surfaces 111a, 111b of the valve plate 110” mean a pair of surfaces each having a plane perpendicular to a thickness direction of the valve plate 110. Also, the “outer peripheral surface 112 of the valve plate 110” means a surface parallel to the thickness direction of the valve plate 110. It should be noted that the term “perpendicular” includes not only completely perpendicular but also substantially perpendicular within a certain error range (i.e., approximately perpendicular). Similarly, the term “parallel” includes not only completely parallel but also substantially parallel within a certain error range (i.e., approximately parallel).

### (1-1. Valve Plate 110)

The shape of the valve plate 110 is not particularly limited as long as it can be provided inside the pipe 10, and it may be set depending on a cross-sectional shape of the pipe 10. For example, as shown in FIG. 2, when the pipe 10 has a circular cross-sectional shape, the valve plate 110 has a disk shape (a circular cross-sectional shape perpendicular to the thickness direction) or an elliptical plate shape (an elliptical cross-sectional shape perpendicular to the thickness direction). Further, when the cross-sectional shape of the pipe 10 is quadrangular, the valve plate 110 may have a quadrangular plate shape (a quadrangular cross-sectional shape perpendicular to the thickness direction).

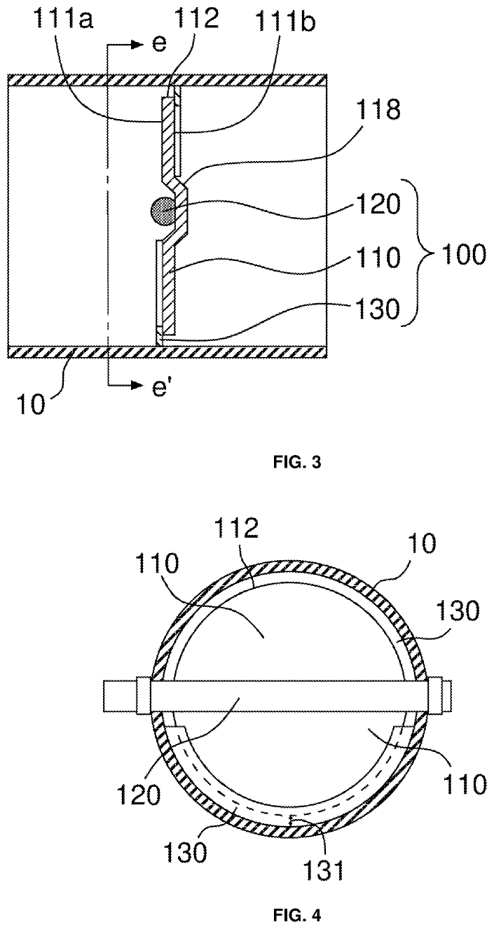

Also, the valve plate 110 may have a stepped portion. Here, FIG. 3 shows a cross-sectional view of the butterfly valve 100 having such a structure according to another embodiment of the present invention, which is parallel to the flow path direction of the first flow path. Also FIG. 4 shows a cross-sectional view taken along the line e-e′ in FIG. 3.

In the butterfly valve 100 shown in FIGS. 3 and 4, a stepped portion 118 is formed at a central portion of the valve plate 110. Such a structure can improve the degree of freedom when providing the shaft 120 to the valve plate 110. Further, the formation of the stepped portion 118 allows thermal deformation of the valve plate 110 to be suppressed.

The valve plate 110 has an outer diameter smaller than an inner diameter of the pipe 10 from the viewpoint of being placed inside the pipe 10. From the viewpoint of ensuring a function of blocking the flow of the first fluid, the outer diameter of the valve plate 110 is preferably 90% or more, and more preferably 95% or more, of the inner diameter of the pipe 10. Also, the outer diameter of the valve plate 110 is preferably 99% or less, and more preferably 98% or less, of the inner diameter of the pipe 10, from the viewpoint of preventing the valve plate 110 from coming into contact with the pipe 10 and from being thermally fixed.

As used herein, the “inner diameter of the pipe 10” means an inner diameter of the cross section of the pipe 10 when the cross section of the pipe 10 is circular, and means a length of one side on an inner side of the cross section of the pipe 10 when the cross section of the pipe 10 is quadrangular. The “outer diameter of the valve plate 110” means a diameter of the cross section of the valve plate 110 when the cross section perpendicular to the thickness direction of the valve plate 110 is circular, and means a length of one side of the cross-section of the valve plate 110 when the cross-sectional shape perpendicular to the thickness direction is quadrangular.

The valve plate 110 preferably has a thickness of 0.1 mm or more, and more preferably 0.5 mm or more, although not particularly limited thereto. The thickness of the valve plate 110 of 0.1 mm or more can ensure the durability and reliability of the valve plate 110. Also, the thickness of the valve plate 110 is preferably 20 mm or less, and more preferably 10 mm or less. The thickness of the valve plate 110 of 20 mm or less allows the weight of the valve plate 110 to be reduced.

The valve plate 110 is preferably made of a metal in terms of manufacturability, although not particularly limited thereto. Also, the valve plate 110 made of a metal is advantageous in that it can be easily welded to the shaft 120 or the like. Examples of the material for the valve plate 110 include stainless steel, titanium alloys, copper alloys, aluminum alloys, and brass. Among these, the stainless steel is preferable because of its high durability reliability and lower cost.

### (1-2. Shaft 120)

The shape of the shaft 120 is not particularly limited as long as it can rotatably support the valve plate 110 inside the pipe 10, and various known shapes can be adopted. For example, as shown in FIG. 2, the shaft 120 can be rod-shaped.

The shaft 120 is directly or indirectly fixed to the valve plate 110. The fixing method is not particularly limited, and it may be fixed by welding, brazing, soldering, diffusion bonding, bolting, screwing, adhesive, or the like. This allows the valve plate 110 to be rotatably supported inside the pipe 10.

The material of the shaft 120 is not particularly limited, but the same material as that of the valve plate 110 can be used.

The shaft 120 is connected to a driving device (not shown) for rotating the shaft 120. The driving device generally includes a motor and gears for transmitting the rotation of the motor to the shaft 120. For example, an actuator can be used as the driving device. The valve plate 110 can be rotated by driving (rotating) the shaft 120 with the driving device. Also, a rotation angle of the valve plate 110 is sufficient to block the flow of the first fluid, and is determined by the shape of the valve plate 110. For example, the angle is 90° when the valve plate 110 is disk-shaped, and is smaller than 90° when the valve plate 110 is elliptical. The value of the rotation angle of the valve plate 110 means the rotation angle on the acute side of the angles formed by the flow path direction of the first fluid flowing through the pipe 10 and normal directions of the plate surfaces 111a, 111b.

### (1-3. Valve Plate Auxiliary Member 130)

The valve plate auxiliary member 130 can have a ring shape having an inner diameter smaller than an outer diameter of the valve plate 110, and having an outer diameter larger than the outer diameter of the valve plate 110 and smaller than an inner diameter of the flow path for the first fluid (pipe 10). The valve plate auxiliary member 130 having such a shape can improve the blocking performance of the first fluid while suppressing the thermal fixation of the valve plate 110. Moreover, the valve plate auxiliary member 130 having such a shape can be easily applied to the existing valve plate 110, so that the production cost of the butterfly valve 100 can be reduced.

As used herein, the “inner diameter of the valve plate auxiliary member 130” having the ring shape is an inner diameter of a cross section of the valve plate auxiliary member 130 when the cross section perpendicular to the thickness direction of the valve plate auxiliary member 130 is circular, and means a length of one side on an inner side of the cross section of the valve plate auxiliary member 130 when the cross section of the valve plate auxiliary member 130 perpendicular to the thickness direction is quadrangular. Further, the “outer diameter of the auxiliary valve plate member 130” having the ring shape is an outer diameter of the cross section of the auxiliary valve plate member 130 when the cross section perpendicular to the thickness direction of the auxiliary valve plate member 130 is circular, and means a length of one side of the valve plate auxiliary member 130 on an outer side of the cross section when the cross section of the valve plate auxiliary member 130 perpendicular to the thickness direction is quadrangular.

The valve plate auxiliary member 130 preferably has a thickness of 0.1 mm or more, and more preferably 0.5 mm or more, although it is not limited thereto. The thickness of the valve plate auxiliary member 130 of 0.1 mm or more can ensure the durability and reliability of the valve plate auxiliary member 130. In particular, the thickness of the valve plate auxiliary member 130 of 0.5 mm or more can also improve the blocking performance of the first fluid. Also, the thickness of the valve plate auxiliary member 130 is preferably 10 mm or less, and more preferably 6 mm or less. The thickness of the valve plate auxiliary member 130 of 10 mm or less enables the weight of the valve plate auxiliary member 130 to be reduced.

The valve plate auxiliary member 130 may be made of a material, including, but not limited to, a metal such as copper, aluminum, iron, nickel, carbon steel, stainless steel, titanium alloys, duralumin alloys, brass, heat-resistant resins, heat-resistant fibers, and heat-resistant rubbers. Also, the valve plate auxiliary member 130 may be in a form of a wire mesh, metal foam, multilayer metal film, or the like.

The Young's modulus of the valve plate auxiliary member 130 is not particularly limited as long as it is lower than the Young's modulus of the valve plate 110, but it may preferably be 1/10 or less, and more preferably 1/100 or less, of the Young's modulus of the valve plate 110. The Young's modulus of the valve plate auxiliary member 130 of 1/10 or less of the Young's modulus of the valve plate 110 can improve the adhesion of the valve plate auxiliary member 130 to the pipe 10, so that the blocking performance of the first fluid can be improved.

The valve plate auxiliary member 130 having the ring shape can be joined to the valve plate 110 by various methods. For example, the valve plate auxiliary member 130 can be joined to the valve plate 110 by welding such as spot welding or using an adhesive.

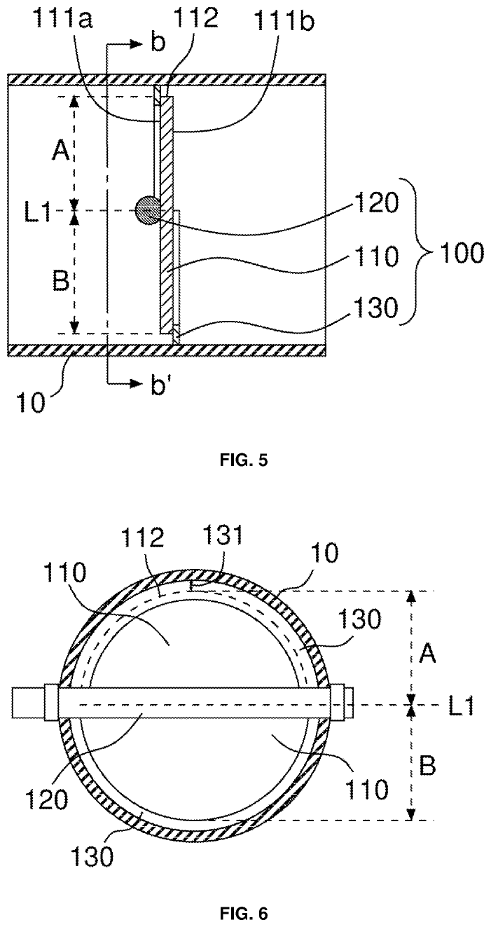

The valve plate auxiliary member 130 may have a halved ring shape in which the above ring shape is divided into halves. Here, FIG. 5 shows a cross-sectional view of the butterfly valve 100 having such a structure according to another embodiment of the present invention, which is parallel to the flow path direction of the first flow path. FIG. 6 shows a cross-sectional view taken along the line b-b′ in FIG. 5.

In the butterfly valve 100 shown in FIGS. 5 and 6, two valve plate auxiliary members 130 each having a halved ring shape are provided so as to be in contact with both plate surfaces 111a, 111b of the valve plate 110, respectively. More particularly, when the valve plate 110 is divided into two regions A and B by a bisector L1 passing through a central axis of the valve plate 110 (a central axis parallel to the thickness direction of the valve plate 110), the two valve plate auxiliary members 130 each having the halved ring shape are provided so as to be in contact with one plate surface 111a of the valve plate 110 in the region A and with the other plate surface 111b of the valve plate 110 in the region B, respectively. The use of such halved ring-shaped auxiliary valve plate members 130 can provide effects of reducing production costs due to reduction of the region for arranging the valve plate auxiliary members 130 and reducing the weight, in addition to the same effect as in the case where the auxiliary valve plate member 130 having the ring shape is used.

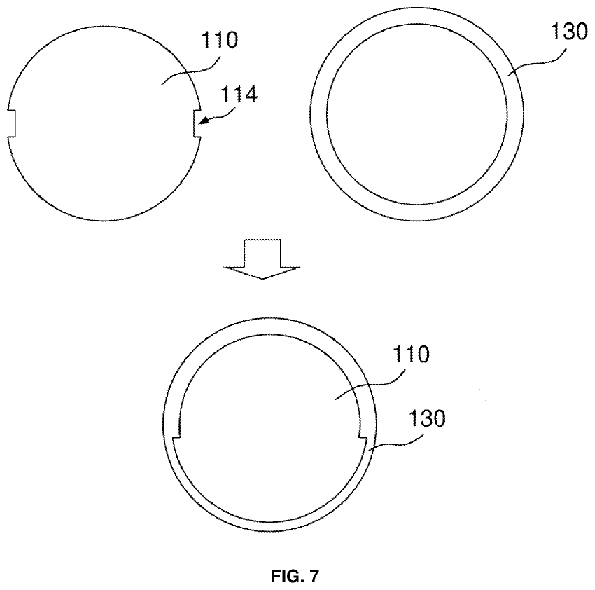

The form of contact with one plate surface 111a of the valve plate 110 in the region A and with the other plate surface 111b of the valve plate 110 in the region B can also be obtained by using one valve plate auxiliary member 130 having the ring shape. Here, FIG. 7 shows plane views of the valve plate 110 and the valve plate auxiliary member 130 used in this embodiment, and a plane view when they are combined. In this embodiment, the valve plate 110 has transition portions 114 so that the valve plate auxiliary member 130 can be in contact with both the one plate surface 111a and the other plate surface 111b. The transition portions 114 may be provided on the bisector L1 passing through the central axis of valve plate 110 (the central axis parallel to the thickness direction of valve plate 110). The shape of each transition portion 114 is not particularly limited, but it may be, for example, a groove shape as shown in FIG. 7. By forming such transition portions 114 in the valve plate 110, the valve plate auxiliary member 130 having one ring shape can be provided such that it can be brought into contact with the one plate surface 111a of the valve plate 110 in the region A and with the other plate surface 111b of the valve plate 110 in the region B.

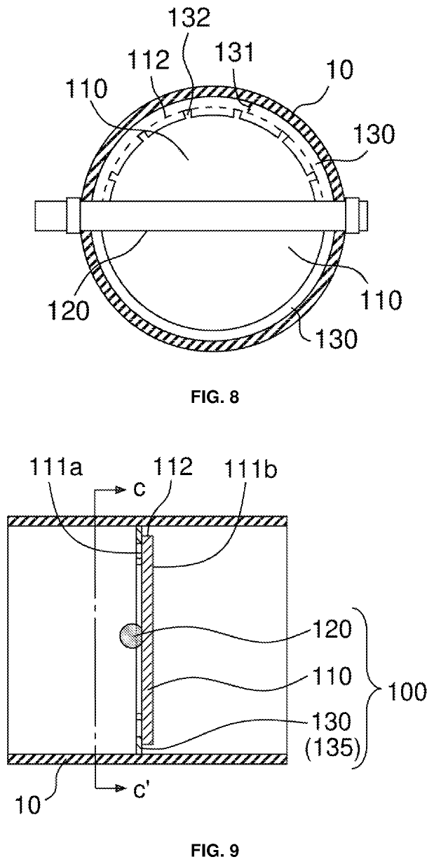

The halved ring shape may have a notch formed on the inner diameter side. Here, FIG. 8 shows a cross-sectional view of the butterfly valve 100 having such a structure according to another embodiment of the present invention, which is perpendicular to the flow path direction of the first flow path. FIG. 8 corresponds to the cross-sectional view taken along the line b-b′ in FIG. 5. A cross-sectional view of the butterfly valve 100 according to this embodiment, which is parallel to the flow path direction of the first flow path, is the same as that of FIG. 5, and so descriptions thereof will be omitted.

As shown in FIG. 8, the butterfly valve 100 according to this embodiment has notches 132 formed on the inner diameter side of the valve plate auxiliary member 130 having the halved ring shape. By providing the notches 132, it is possible to suppress separation of the valve plate auxiliary member 130 from the valve plate 110 due to thermal expansion of the valve plate auxiliary member 130 in the circumferential direction. In addition, it allows a weldable region to be increased when the valve plate auxiliary member 130 is joined to the valve plate 110 by welding, and also allows the weight of the valve plate auxiliary member 130 to be reduced. Further, the valve plate auxiliary member 130 can be installed even if the size of the valve plate 110 is varied, by adjusting an amount of bending in the circumferential direction. In other words, it is not necessary to produce the valve plate auxiliary member 130 in response to the sizes of the valve plates 110 one by one, so that the production cost of the butterfly valve 100 is reduced.

The number and size of the notches 132 are not particularly limited, and they may be appropriately adjusted depending on the size of the valve plate auxiliary member 130 or the like. The number of the notches 132 can be, for example, 2 to 30. Also, the depth of each notch 132 may be, for example, approximately a depth corresponding to a distance from the inner peripheral surface of the valve plate auxiliary member 130 to the outer peripheral surface 112 of the valve plate 110. Furthermore, the width of each notch 132 can be, for example, 0.1 to 10 mm.

Also, although not shown, the notches may be formed on the inner diameter side of the valve plate auxiliary member 130 having the ring shape as shown in FIGS. 1 and 2. Even with such a structure, the same effect as described above can be obtained.

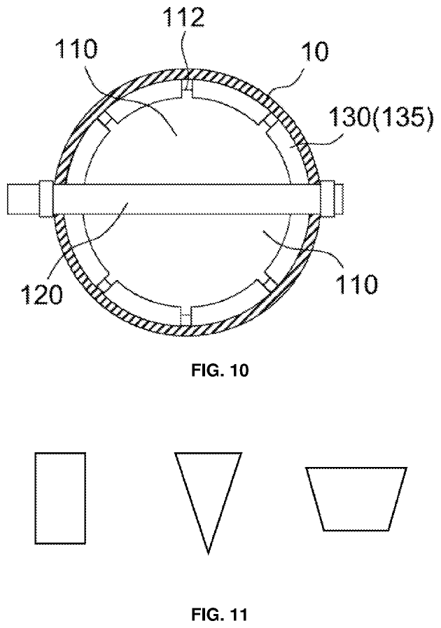

The valve plate auxiliary member 130 may be constructed from two or more valve plate auxiliary member pieces that are not in contact with each other. Here, FIG. 9 shows a cross-sectional view of the butterfly valve 100 having such a structure according to another embodiment of the present invention, which is parallel to the flow path direction of the first flow path. Also, FIG. 10 shows a cross-sectional view taken along the line c-c′ in FIG. 9.

It should be noted that although the butterfly valve 100 shown in FIGS. 9 and 10 is an example in which a valve plate auxiliary member 130 composed of two or more valve plate auxiliary member pieces 135 is provided so as to come into contact with the one plate surface 111a of the valve plate 110, the valve plate auxiliary member 130 may be constructed from two or more valve plate auxiliary member pieces 135 so as to be in contact with both (two) of the plate surfaces 111a, 111b of the valve plate 110, respectively. Further, it should be noted that, when the valve plate 110 is divided into the two regions A and B by the bisector L1 passing through the central axis of the valve plate 110 (the central axis parallel to the thickness direction of the valve plate 110), the valve plate auxiliary member 130 composed of two or more valve plate auxiliary member pieces 135 is provided so as to be in contact with the one plate surface 111a of the valve plate 110 in the region A and with the other plate surface 111b of the valve plate 110 in the region B.

As shown in FIGS. 9 and 10, the valve plate auxiliary member 130 is constructed using the two or more valve plate auxiliary member pieces 135 that are not in contact with each other, so that a degree of freedom for providing the valve plate auxiliary member 130 to the valve plate 11 can be improved. Further, when the flow of the first fluid is blocked, the first fluid slightly passes through a space between the two or more valve plate auxiliary member pieces 135 that are not in contact with each other, so that it is also possible to prevent an internal pressure from becoming excessively high.

The shape of the valve plate auxiliary member piece 135 is not particularly limited, and various shapes are possible. Examples of the shape of the valve plate auxiliary member piece 135 include, in addition to the fan shape shown in FIG. 10, polygons such as triangles and quadrangles as shown in FIG. 11, trapezoids, and the like. FIG. 11 shows plane views of the valve plate auxiliary member pieces 135. The sizes of these shapes (arc length, length of one side, etc.) are not particularly limited, and they may be appropriately adjusted depending on the size of the valve plate 110.

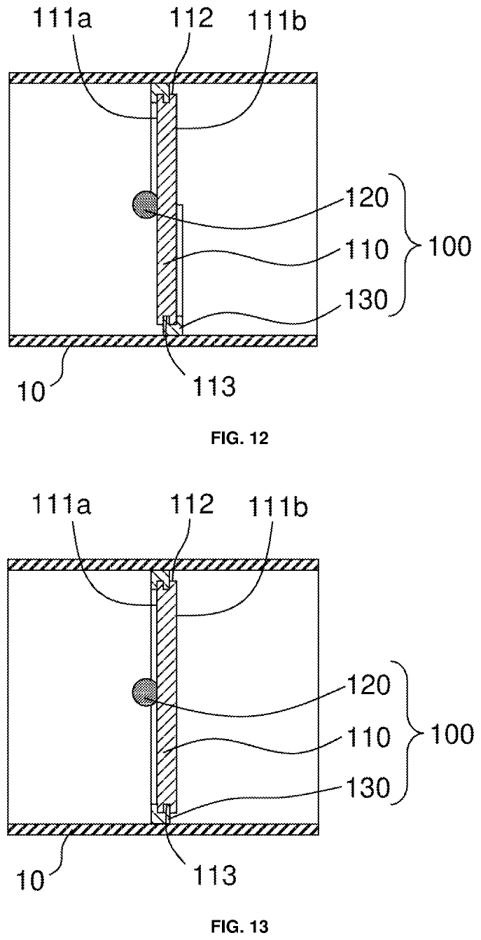

When the valve plate 110 has at least one groove portion 113 on an outer peripheral surface 112, at least a part of the valve plate auxiliary member 130 can be arranged in the groove portion 113. Here, FIG. 12 shows a cross-sectional view of the butterfly valve 100 having such a structure according to another embodiment of the present invention, which is parallel to the flow path direction of the first flow path. FIG. 12 corresponds to the same cross-sectional view as FIG. 12. In FIG. 12, the cross-sectional view corresponding to the cross-sectional view taken along the line b-b′ in FIG. 5 is the same as FIG. 6, and so descriptions thereof will be omitted.

By arranging at least a part of the valve plate auxiliary member 130 in the groove portion 113 of the valve plate 110 as shown in FIG. 12, the joining force of the valve plate auxiliary member 130 to the valve plate 110 is increased, and the reliability is improved. Further, the valve plate auxiliary member 130 is installed using the outer peripheral surface 112 or the groove portion 113 as a reference for positioning, so that it is possible to reduce variations in the installation position in the radial direction. As a result, a variation in blocking performance when the butterfly valve 100 blocks the flow of the first fluid can be reduced.

Although FIG. 12 shows an example in which the valve plate auxiliary member 130 is provided so as to be in contact with the two plate surfaces 111a, 111b of the valve plate 110, the valve plate auxiliary member 130 may be provided so as to be in contact with one plate surface 111a of the valve plate 110 as shown in FIG. 13. Such a structure also increases the joining force of the valve plate auxiliary member 130 to the valve plate 110 and improves the reliability. It should be noted that FIG. 13 is a cross-sectional view of the butterfly valve 100 according to another embodiment of the present invention, which is parallel to the flow path direction of the first flow path, as with FIG. 12.

The valve plate 110 having the groove portion 113 may be formed by processing one plate, but it may have a three-layer structure in which a third plate is sandwiched between a first plate and a second plate, the third plate having a smaller diameter than the first plate and second plate. Such a structure allows the groove portion 113 to be easily formed in the valve plate 110. A method for joining the plates is not particularly limited, and a known method can be used.

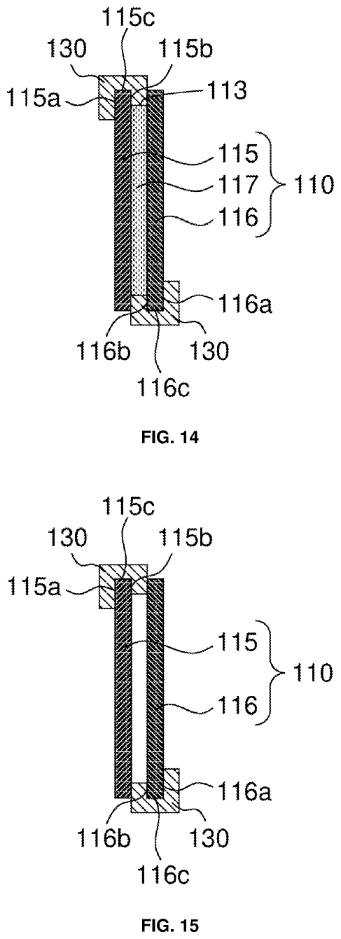

When using the valve plate 110 having the three-layer structure, the valve plate auxiliary member 130 preferably has a structure that is in contact with both plate surfaces and the outer peripheral surface(s) of the first plate and/or the second plate. Here, FIG. 14 shows a cross-sectional view of the butterfly valve 100 having such a structure. In FIG. 14, the shaft 120 is omitted from the viewpoint of easy understanding, and it shows a cross-sectional view parallel to the flow path direction of the first fluid when it is provided in the flow path for the first fluid.

As shown in FIG. 14, the valve plate 110 includes a first plate 115, a second plate 116, and a third plate 117 sandwiched between the first plate 115 and the second plate 116. Since the third plate 117 has a smaller diameter than the first plate 115 and the second plate 116, the groove portions 113 formed by opposing surfaces of the first plate 115 and the second plate 116 and the outer peripheral surface of the third plate 117 are formed. One valve plate auxiliary member 130 is in contact with both plate surfaces 115a, 115b and an outer peripheral surface 115c of the first plate 115, and the other valve plate auxiliary member 130 is in contact with both plate surfaces 116a, 116b and an outer peripheral surface 116c of the second plate 116. Such a structure increases the joining force of the valve plate auxiliary member 130 to the valve plate 110, and improve the reliability.

It should be noted that the valve plate auxiliary member 130 may be in contact with only the plate surfaces 115a, 115b and the outer peripheral surface 115c of the first plate 115, or may be in contact with only both the plate surfaces 116a, 116b and the outer peripheral surface 116c of the second plate 116.

When the valve plate 110 is composed of the first plate 115 and the second plate 116, at least a part of the valve plate auxiliary member 130 can be arranged between the first plate 115 and the second plate 116. Here, FIG. 15 shows a cross-sectional view of the butterfly valve 100 having such a structure. In FIG. 15, the shaft 120 is omitted from the viewpoint of easy understanding as in FIG. 14, and it shows a cross-sectional view parallel to the flow path direction of the first flow path when it is provided in the flow path for the first fluid.

As shown in FIG. 15, the valve plate 110 is composed of the first plate 115 and the second plate 116, and a space is between the first plate 115 and the second plate 116. One valve plate auxiliary member 130 is in contact with both plate surfaces 115a, 115b and the outer peripheral surface 115c of the first plate 115, and the other valve plate auxiliary member 130 is in contact with both plate surfaces 116a, 116b and the outer peripheral surface 116c of the second plate 116. Such a structure increases the joining force of the valve plate auxiliary member 130 to the valve plate 110, and improves the reliability. Also, since there is the space between the first plate 115 and the second plate 116, a heat insulating effect can be obtained, so that heat radiation from the valve plate 110 is suppressed.

It should be noted that the valve plate auxiliary member 130 may be only in contact with both plate surfaces 115a, 115b and the outer peripheral surface 115c of the first plate 115, or may only in contact with both plate surfaces 116a, 116b and the outer peripheral surface 116c of the second plate 116.

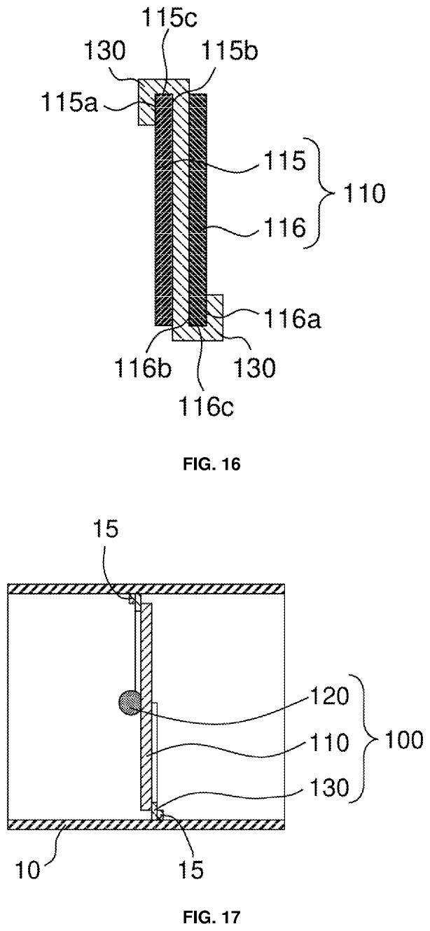

Although the space region is formed between the first plate 115 and the second plate 116 in FIG. 15, the region may be the valve plate auxiliary member 130. FIG. 16 shows a cross-sectional view of the butterfly valve 100 having such a structure. In FIG. 16, the shaft 120 is omitted from the viewpoint of easy understanding as in FIG. 14, and it shows a cross-sectional view parallel to the flow path direction of the first flow path when it is provided in the flow path for the first fluid. Such a structure increases the joining force of the valve plate auxiliary member 130 to the valve plate 110, and improves the reliability.

### (2. Flow Path for First Fluid)

The butterfly valve 100 is provided inside the pipe 10 which is the flow path for the first fluid. The pipe 10 is not particularly limited as long as it can accommodate the butterfly valve 100.

The pipe 10 is preferably made of a material, including, but not limited to, a metal from the viewpoint of manufacturability. Examples of the material for the pipe 10 include stainless steel, titanium alloys, copper alloys, aluminum alloys, and brass. Among these, the stainless steel is preferable because of its high durability reliability and low cost.

The pipe 10 preferably has a thickness of 0.1 mm or more, and more preferably 0.3 mm or more, and still more preferably 0.5 mm or more, although not particularly limited thereto. The thickness of the pipe 10 of 0.1 mm or more can ensure durability and reliability. Also, the thickness of the pipe 10 is preferably 10 mm or less, and more preferably 5 mm or less, and even more preferably 3 mm or less. The thickness of the pipe 10 of 10 mm or less allows thermal resistance to be reduced and thermal conductivity to be enhanced.

On the inner peripheral portion of the flow path (pipe 10) for the first fluid can be a stopper portion(s) 15 that can be in contact with the valve plate 110 and/or the valve plate auxiliary member 130. Here, FIG. 17 is a cross-sectional view of the butterfly valve 100 having such a structure provided in the flow path for the first fluid according to another embodiment of the present invention, which is parallel to the flow path direction of the first flow path. It should be noted that FIG. 17 shows the butterfly valve 100 having the structure shown in FIG. 5 as an example.

As shown in FIG. 17, the stopper portions 15 are formed on the inner peripheral portion of the pipe 10 so as to be in contact with the valve plate auxiliary members 130. It should be noted that although FIG. 17 shows the stopper portions 15 that can be in contact with the valve plate auxiliary members 130 as an example, the stopper portions 15 may be in contact with the valve plate 110 or both the valve plate 110 and the valve plate auxiliary member 130. When the stopper portion 15 is not formed on the inner peripheral portion of the pipe 10, a gap is generated between the pipe 10 and the valve plate 110 and/or the valve plate auxiliary member 130, and the first fluid may pass through the gap, resulting in deterioration of heat recovery performance. However, by providing the stopper portions 15 on the inner peripheral portion of the pipe 10, the valve plate 110 and/or the valve plate auxiliary member 130 can be brought into contact with the stopper portions 15, thereby solving the above problem. More particularly, it is difficult to generate the gap by bringing the stopper portions 15 into contact with the valve plate 110 and/or the valve plate auxiliary members 130, thereby improving the heat recovery performance.

The material of the stopper portion 15 is not particularly limited, and the same material as that of the pipe 10 can be used.

### (3. Heat Exchanger)

The butterfly valve 100 according to the embodiment of the heat exchanger of the present invention has the structure as described above, so that it is possible to improve the blocking performance of the exhaust gas while suppressing thermal fixing and the butterfly valve 100 can be used for the heat exchanger. Therefore, the heat exchanger according to an embodiment of the invention includes the butterfly valve 100 described above. In this heat exchanger, the structures other than the butterfly valve 100 are not particularly limited, and known structures can be adopted. Structural examples of a typical heat exchanger will be described below.

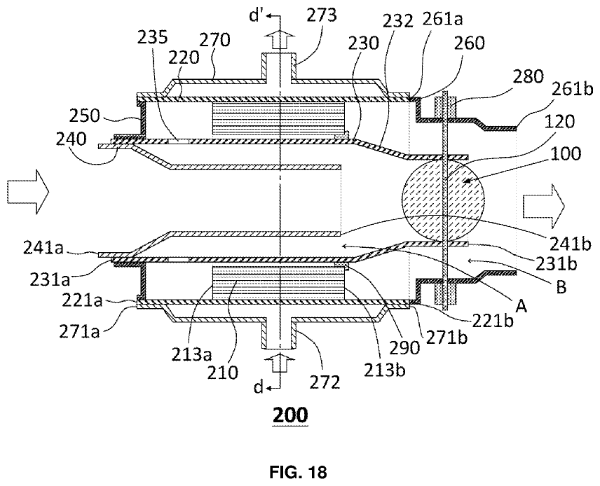

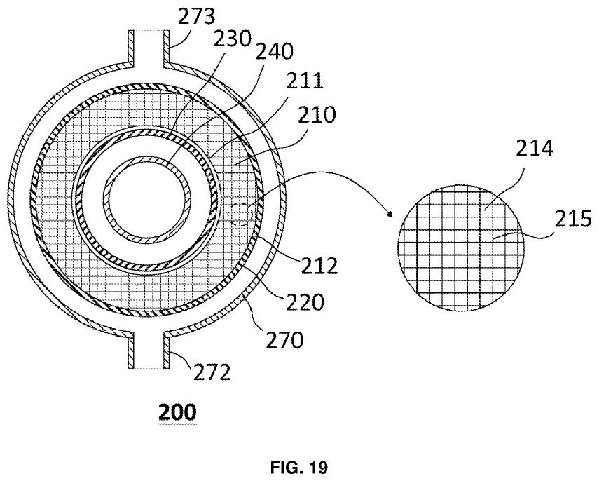

FIG. 18 is a cross-sectional view of a heat exchanger according to an embodiment of the present invention, which is parallel to a flow path direction of a first fluid. Also, FIG. 19 is a cross-sectional view taken along the line d-d′ in the heat exchanger in FIG. 18.

As shown in FIGS. 18 and 19, a heat exchanger 200 according an embodiment of the present invention includes: a hollow pillar shaped honeycomb structure 210 (which may be abbreviated as a “pillar shaped honeycomb structure); and an inner cylindrical member 230 fitted to a surface of an inner peripheral wall of the pillar shaped honeycomb structure 210, wherein the butterfly valve 100 is provided on a downstream end portion side of the inner cylindrical member 230. Also, the heat exchanger 200 can further include: a first outer cylindrical member 220 fitted to a surface of an outer peripheral wall of the pillar shaped honeycomb structure 210; an upstream cylindrical member 240 having a portion arranged on a radially inner side of the inner cylindrical member 230 at a distance so as to form a flow path for the first fluid; a cylindrical connecting member 250 for connecting an upstream end portion of the first outer cylindrical member 220 to an upstream side of the inner cylindrical member 230; a downstream cylindrical member 260 connected to a downstream end portion of the first outer cylindrical member 220, the downstream cylindrical member 260 having a portion arranged on a radially outer side of the inner cylindrical member 230 at a distance so as to form the flow path for the first fluid; and a second outer cylindrical member 270 arranged on a radially outer side of the first outer cylinder member 220 at a distance so as to form a flow path for a second fluid. The inner cylindrical member 230 has at least one through hole 235 through which the first fluid flowing through the flow path between the inner cylindrical member 230 and the upstream cylindrical member 240 can be introduced into the pillar shaped honeycomb structure 210. It should be noted that the butterfly valve 100 may be fixed to the shaft 120 which is rotatably supported by a bearing 280 arranged on a radially outer side of the downstream cylindrical member 260, and which is arranged so as to pass through the downstream cylindrical member 260 and the inner cylindrical member 230.

### <Hollow Pillar Shaped Honeycomb Structure 210>

The hollow pillar shaped honeycomb structure 210 includes an inner peripheral wall 211, an outer peripheral wall 212, and a partition wall 215 which is disposed between the inner peripheral wall 211 and the outer peripheral wall 212, and which defines a plurality of cells 214 extending from a first end face 213a to a second end face 213b to form flow paths for a first fluid.

As used herein, the “hollow pillar shaped honeycomb structure 210” refers to a pillar shaped honeycomb structure 210 having a hollow region at a central portion in a cross section of the hollow pillar shaped honeycomb structure 210, which is perpendicular to the flow path direction of the first fluid.

A shape (outer shape) of the hollow pillar shaped honeycomb structure 210 is not particularly limited, but it may be, for example, a circular pillar shape, an elliptical pillar shape, a quadrangular pillar shape, or other polygonal pillar shape.

Also, a shape of the hollow region in the hollow pillar shaped honeycomb structure 210 is not particularly limited, but it may be, for example, a circular pillar shape, an elliptical pillar shape, a quadrangular pillar shape, or other polygonal pillar shape.

It should be note that the shape of the hollow pillar shaped honeycomb structure 210 and the shape of the hollow region may be the same as or different from each other. However, they are preferably the same as each other, in terms of resistance to external impact, thermal stress, and the like.

Each cell 214 may have any shape, including, but not particularly limited to, circular, elliptical, triangular, quadrangular, hexagonal and other polygonal shapes in a cross section in a direction perpendicular to a flow path direction of the first fluid. Also, the cells 214 are radially provided in a cross section in a direction perpendicular to the flow path direction of the first fluid. Such a structure can allow heat of the first fluid flowing through the cells 214 to be efficiently transmitted to the outside of the hollow pillar shaped honeycomb structure 210.

A thickness of the partition wall 215 may preferably be from 0.1 to 1 mm, and more preferably from 0.2 to 0.6 mm, although not particularly limited thereto. The thickness of the partition wall 215 of 0.1 mm or more can provide the hollow pillar shaped honeycomb structure 210 with a sufficient mechanical strength. Further, the thickness of the partition wall 215 of 1.0 mm or less can suppress problems that the pressure loss is increased due to a decrease in an opening area and the heat recovery efficiency is decreased due to a decrease in a contact area with the first fluid.

Each of the inner peripheral wall 211 and the outer peripheral wall 212 preferably has a thickness larger than that of the partition wall 215, although not particularly limited thereto. Such a structure can lead to increased strength of the inner peripheral wall 211 and the outer peripheral wall 212 which would otherwise tend to generate breakage (e.g., cracking, chinking, and the like) by external impact, thermal stress due to a temperature difference between the first fluid and the second fluid, and the like.

In addition, the thicknesses of the inner peripheral wall 211 and the outer peripheral wall 212 are not particularly limited, and they may be adjusted as needed according to applications and the like. For example, the thickness of each of the inner peripheral wall 211 and the outer peripheral wall 212 is preferably from 0.3 mm to 10 mm, and more preferably from 0.5 mm to 5 mm, and even more preferably from 1 mm to 3 mm, when using the heat exchange 100 for general heat exchange applications. Moreover, when using the heat exchanger 200 for heat storage applications, the thickness of the outer peripheral wall 212 is preferably 10 mm or more, in order to increase a heat capacity of the outer peripheral wall 212.

The partition wall 215, the inner peripheral wall 211 and the outer peripheral wall 212 preferably contain ceramics as a main component. The phrase “contain ceramics as a main component” means that a ratio of a mass of ceramics to the mass of the total component is 50% by mass or more.

Each of the partition wall 215, the inner peripheral wall 211 and the outer peripheral wall 212 preferably has a porosity of 10% or less, and more preferably 5% or less, and even more preferably 3% or less, although not particularly limited thereto. Further, the porosity of the partition wall 215, the inner peripheral wall 211 and the outer peripheral wall 212 may be 0%. The porosity of the partition wall 215, the inner peripheral wall 211 and the outer peripheral wall 212 of 10% or less can lead to improvement of thermal conductivity.

The partition wall 215, the inner peripheral wall 211 and the outer peripheral wall 212 preferably contain SiC (silicon carbide) having high thermal conductivity as a main component. Examples of such a material includes Si-impregnated SiC, (Si+Al) impregnated SiC, a metal composite SiC, recrystallized SiC, Si₃N₄, SiC, and the like. Among them, Si-impregnated SiC and (Si+Al) impregnated SiC are preferably used because they can allow for production at lower cost and have high thermal conductivity.

A cell density (that is, the number of cells 214 per unit area) in the cross section of the hollow pillar shaped honeycomb structure 210 perpendicular to the flow path direction of the first fluid is preferably in a range of from 4 to 320 cells/cm 2, although not particularly limited thereto. The cell density of 4 cells/cm 2 or more can sufficiently ensure the strength of the partition wall 215, hence the strength of the hollow pillar shaped honeycomb structure 210 itself and effective GSA (geometrical surface area). Further, the cell density of 320 cells/cm 2 or less can allow prevention of an increase in a pressure loss when the first fluid flows.

The hollow pillar shaped honeycomb structure 210 preferably has an isostatic strength of more than 100 MPa, and more preferably 150 MPa or more, and still more preferably 200 MPa or more, although not particularly limited thereto. The isostatic strength of the hollow pillar shaped honeycomb structure 210 of 100 MPa or more can lead to the hollow pillar shaped honeycomb structure 210 having improved durability. The isostatic strength of the hollow pillar shaped honeycomb structure 210 can be measured according to the method for measuring isostatic strength as defied in the JASO standard M505-87 which is a motor vehicle standard issued by Society of Automotive Engineers of Japan, Inc.

A diameter (an outer diameter) of the outer peripheral wall 212 in the cross section in direction perpendicular to the flow path direction of the first fluid may preferably be from 20 to 200 mm, and more preferably from 30 to 100 mm, although not particularly limited thereto. Such a diameter can allow heat recovery efficiency to be improved. When the shape of the outer peripheral wall 212 is not circular, the diameter of the largest inscribed circle that is inscribed in the cross-sectional shape of the outer peripheral wall 212 is defined as the diameter of the outer peripheral wall 212.

Further, a diameter of the inner peripheral wall 211 in the cross section in the direction perpendicular to the flow path direction of the first fluid may preferably be from 1 to 50 mm, and more preferably from 2 to 30 mm, although not particularly limited thereto. When the cross-sectional shape of the inner peripheral wall 211 is not circular, the diameter of the largest inscribed circle that is inscribed in the cross-sectional shape of the inner peripheral wall 211 is defined as the diameter of the inner peripheral wall 211.

The hollow pillar shaped honeycomb structure 210 preferably has a thermal conductivity of 50 W/(m·K) or more at 25° C., and more preferably from 100 to 300 W/(m·K), and even more preferably from 120 to 300 W/(m·K), although not particularly limited thereto. The thermal conductivity of the hollow pillar shaped honeycomb structure 210 in such a range can lead to an improved thermal conductivity and can allow the heat inside the hollow pillar shaped honeycomb structure 210 to be efficiently transmitted to the outside. It should be noted that the value of thermal conductivity is a value measured according to the laser flash method (JIS R 1611: 1997).

In the case where an exhaust gas as the first fluid flows through the cells 214 in the hollow pillar shaped honeycomb structure 210, a catalyst may be supported on the partition wall 215 of the pillar shaped honeycomb structure 210. The supporting of the catalyst on the partition wall 215 can allow CO, NOx, HC and the like in the exhaust gas to be converted into harmless substances through catalytic reaction, and can also allow reaction heat generated during the catalytic reaction to be utilized for heat exchange. Preferable catalysts include those containing at least one element selected from the group consisting of noble metals (platinum, rhodium, palladium, ruthenium, indium, silver and gold), aluminum, nickel, zirconium, titanium, cerium, cobalt, manganese, zinc, copper, tin, iron, niobium, magnesium, lanthanum, samarium, bismuth, and barium. Any of the above-listed elements may be contained as a metal simple substance, a metal oxide, or other metal compound.

A supported amount of the catalyst (catalyst metal+support) may preferably be from 10 to 400 g/L, although not particularly limited thereto. Further, when using the catalyst containing the noble metal(s), the supported amount may preferably be from 0.1 to 5 g/L, although not particularly limited thereto. The supported amount of the catalyst (catalyst metal+support) of 10 g/L or more can easily achieve catalysis. Also, the supported amount of the catalyst (catalyst metal+support) of 400 g/L or less can allow suppression of both an increase in a pressure loss and an increase in a manufacturing cost. The support refers to a carrier on which a catalyst metal is supported. Examples of the supports include those containing at least one selected from the group consisting of alumina, ceria and zirconia.

### <First Outer Cylindrical Member 220>

The first outer cylindrical member 220 is fitted to a surface (outer peripheral surface) of the outer peripheral wall 212 of the pillar shaped honeycomb structure 210. The fitting may be either directly or indirectly performed, but it may preferably be directly performed in terms of heat recovery efficiency.

The first outer cylindrical member 220 is a cylindrical member having an upstream end portion 221a and a downstream end portion 221b.

It is preferable that an axial direction of the first outer cylindrical member 220 coincides with that of the pillar shaped honeycomb structure 210, and a central axis of the first outer cylindrical member 220 coincides with that of the pillar shaped honeycomb structure 210. Also, a central position of the first outer cylindrical member 220 in an axial direction may coincide with that of the pillar shaped honeycomb structure 210 in the axial direction. Further, diameters (an outer diameter and an inner diameter) of the first outer cylindrical member 220 may be uniform in the axial direction, but the diameter of at least a part (for example, both ends in the axial direction or the like) of the first outer cylinder may be increased or decreased.

Non-limiting examples of the first outer cylindrical member 220 that can be used herein include a cylindrical member fitted to the surface of the outer peripheral wall 212 of the pillar shaped honeycomb structure 210 to cover circumferentially the outer peripheral wall 212 of the pillar shaped honeycomb structure 210.

As used herein, the “fitted” means that the pillar shaped honeycomb structure 210 and the first outer cylindrical member 220 are fixed in a state of being suited to each other. Therefore, the fitting of the pillar shaped honeycomb structure 210 and the first outer cylindrical member 220 encompasses cases where the pillar shaped honeycomb structure 210 and the first outer cylindrical member 220 are fixed to each other by a fixing method based on fitting such as clearance fitting, interference fitting and shrinkage fitting, as well as by brazing, welding, diffusion bonding, and the like.

The first outer cylindrical member 220 may preferably have an inner surface shape corresponding to the surface of the outer peripheral wall 212 of the pillar shaped honeycomb structure 210. Since the inner surface of the first outer cylindrical member 220 is in direct contact with the outer peripheral wall 212 of the pillar shaped honeycomb structure 210, the thermal conductivity is improved and the heat in the pillar shaped honeycomb structure 210 can be efficiently transferred to the first outer cylindrical member 220.

In terms of improvement of the heat recovery efficiency, a higher ratio of an area of a portion circumferentially covered with the first outer cylindrical member 220 in the outer peripheral wall 212 of the pillar shaped honeycomb structure 210 to the total area of the outer peripheral wall 212 of the pillar shaped honeycomb structure 210 is preferable. Specifically, the area ratio is preferably 80% or more, and more preferably 90% or more, and even more preferably 100% (that is, the entire outer peripheral wall 212 of the pillar shaped honeycomb structure 210 is circumferentially covered with the first outer cylindrical member 220).

It should be noted that the term “the surface of the outer peripheral wall 212” as used herein refers to a surface of the pillar shaped honeycomb structure 210, which is parallel to the flow path direction of the first fluid, and does not include surfaces (the first end face 213a and the second end face 213b) of the pillar shaped honeycomb structure 210, which are perpendicular to the flow path direction of the first fluid.

The first outer cylindrical member 220 is preferably made of a metal in terms of manufacturability, although not particularly limited thereto. Further, the metallic first outer cylindrical member 220 is also preferable in that it can be easily welded to a second outer cylindrical member 270 or the like, which will be described below. Examples of the material of the first outer cylindrical member 220 that can be used herein include stainless steel, titanium alloys, copper alloys, aluminum alloys, brass and the like. Among them, the stainless steel is preferable because it has high durability and reliability and is inexpensive.

The first outer cylindrical member 220 preferably has a thickness of 0.1 mm or more, and more preferably 0.3 mm or more, and still more preferably 0.5 mm or more, although not particularly limited thereto. The thickness of the first outer cylindrical member 220 of 0.1 mm or more can ensure durability and reliability. The thickness of the first outer cylindrical member 220 is preferably 10 mm or less, and more preferably 5 mm or less, and still more preferably 3 mm or less. The thickness of the first outer cylindrical member 220 of 10 mm or less can reduce thermal resistance and improve thermal conductivity.

### <Inner Cylindrical Member 230>

The inner cylindrical member 230 is fitted to a surface (an inner peripheral surface) of the inner peripheral wall 211 of the pillar shaped honeycomb structure 210. The fitting may be directly performed or indirectly performed via a seal member 290 or the like.

The inner cylindrical member 230 is a cylindrical member having an upstream end portion 231a and a downstream end portion 231b.

The inner cylindrical member 230 preferably has a tapered portion 232 whose diameter is reduced from the position of the second end face 213b of the pillar shaped honeycomb structure 210 to the downstream end portion 231b. The providing of such a tapered portion 232 can reduce a difference between the inner diameter of the downstream end portion 231b of the inner cylindrical member 230 and the inner diameter of the downstream end portion 241b of the upstream cylindrical member 240. In this case, when heat recovery is suppressed, it can achieve the equivalent flow rate of the first fluid in the vicinity of the downstream end portion 241b of the upstream cylindrical member 240 to that of the first fluid in the vicinity of the downstream end portion 231b of the inner cylindrical member 230, thus decreasing a difference between pressures in the vicinity of the downstream end portion 241b of the upstream cylindrical member 240 and in the vicinity of the downstream end portion 231b of the inner cylindrical member 230. As a result, the backward flow phenomenon of the first fluid flowing from a heat recovery path outlet B to a heat recovery path inlet A can be suppressed, so that the heat insulation performance can be improved.

The tapered portion 232 has an inclination angle of the inner cylindrical member 230 relative to the axial direction of, preferably 45° or less, and more preferably 42° or less, and still more preferably 40° or less. The controlling of the inclination angle to such an angle can suppress the flow of the first fluid passing between the inner cylindrical member 230 and the upstream cylindrical member 240 to enter the pillar shaped honeycomb structure 210, when heat recovery is suppressed, so that the heat insulation performance can be improved.

In addition, the lower limit of the inclination angle of the tapered portion 232 is not particularly limited, but it may generally be 10°, and preferably 15°, in terms of provide the compact heat exchanger 200.

The inner cylindrical member 230 has at least one through hole 235 through which the first fluid flowing through the flow path between the inner cylindrical member 230 and the upstream cylindrical member 240 can be introduced into the pillar shaped honeycomb structure 210. The shape and number of the through holes 235 are not particularly limited, and known shape and number can be adopted.

It is preferable that an axial direction of the inner cylindrical member 230 coincides with that of the pillar shaped honeycomb structure 210, and a central axis of the inner cylindrical member 230 coincides with that of the pillar shaped honeycomb structure 210. Further, it is also preferable that an axial center position of the inner cylindrical member 230 coincides with that of the pillar shaped honeycomb structure 210.

Non-limiting examples of the inner cylindrical member 230 that can be used herein includes a cylindrical member in which a part of the outer peripheral surface of the inner cylindrical member 230 is fitted to the surface of the inner peripheral wall 211 of the pillar shaped honeycomb structure 210.

Here, a part of the outer peripheral surface of the inner cylindrical member 230 and the surface of the inner peripheral wall 211 of the pillar shaped honeycomb structure 210 may be in direct contact with each other or indirect contact with each other via another member (e.g., a heat insulating mat).

The part of the outer peripheral surface of the inner cylindrical member 230 and the surface of the inner peripheral wall 211 of the pillar shaped honeycomb structure 210 are fixed to each other in a state where they are fitted to each other. A fixing method includes, but not limited to, the same method as that of the first outer cylindrical member 220 as described above.

A material of the inner cylindrical member 230 includes, but not limited to, the same materials as those of the first outer cylindrical member 220 as described above.

A thickness of the inner cylindrical member 230 includes, but not limited to, the same thickness as that of the first outer cylindrical member 220 as described above.

### <Upstream Cylindrical Member 240>

The upstream cylindrical member 240 has a portion arranged on a radially inner side of the inner cylindrical member 230 at a distance so as to form a flow path for the first fluid.

The upstream cylindrical member 240 is a cylindrical member having an upstream end portion 241a and a downstream end portion 241b.

It is preferable that an axial direction of the upstream cylindrical member 240 coincides with that of the pillar shaped honeycomb structure 210, and a central axis of the upstream cylindrical member 240 coincides with that of the pillar shaped honeycomb structure 210.

The structure of the upstream cylindrical member 240 on the upstream end portion 241a side is not particularly limited, but it may be adjusted as needed, depending on the shape of other component (e.g., piping) to which the upstream end portion 241a of the upstream cylindrical member 240 is connected. For example, when the diameter of the other component is larger than that of the upstream end portion 241a, the diameter on the upstream end portion 241a side may be increased as shown in FIG. 18.

A method of fixing the upstream cylindrical member 240 is not particularly limited, but the upstream cylindrical member 240 may be fixed to the first outer cylindrical member 220 or the like via a cylindrical connecting member 250 described below. The fixing method includes, but not limited to, the same method as that of the first outer cylindrical member 220 as described above.

A material of the upstream cylindrical member 240 includes, but not limited to, the same materials as those of the first outer cylindrical member 220 as listed above.

A thickness of the upstream cylindrical member 240 includes, but not limited to, the same thickness as that of the first outer cylindrical member 220 as described above.

### <Cylindrical Connecting Member 250>

The cylindrical connecting member 250 is a cylindrical member that connects the upstream end portion 221a of the first outer cylindrical member 220 to the upstream side of the inner cylindrical member 230. The connection may be direct or indirect. In the case of indirect connection, for example, an upstream end portion 271a of a second outer cylindrical member 270, which will be described later, or the like may be arranged between the upstream end portion 221a of the first outer cylindrical member 220 and the upstream side of the inner cylindrical member 230.

It is preferable that an axial direction of the cylindrical connecting member 250 coincides with that of the pillar shaped honeycomb structure 210, and a central axis of the cylindrical connecting member 250 coincides with that of the pillar shaped honeycomb structure 210.

The shape of the cylindrical connecting member 250 is not particularly limited, but it may have a curved structure. Such a structure can provide smooth flowing of the first fluid entering through the heat recovery path inlet A to flows to the pillar shaped honeycomb structure 210 during promotion of heat recovery, so that the pressure loss can be reduced.

A material of the cylindrical connecting member 250 includes, but not limited to, the same materials as those of the first outer cylindrical member 220 as listed above.

A thickness of the cylindrical connecting member 250 includes, but not limited to, the same thickness as that of the first outer cylindrical member 220 as described above.

### <Downstream Cylindrical Member 260>

The downstream cylindrical member 260 is connected to the downstream end portion 221b of the first outer cylindrical member 220 and has a portion which is arranged on a radially outer side of the inner cylindrical member 230 at a distance so as to form the flow path for the first fluid. The connection may be either direct or indirect. In the case of indirect connection, for example, a downstream end portion 271b of a second outer cylindrical member 270 which will be described below, or the like, may be arranged between the downstream cylindrical member 260 and the downstream end portion 221b of the first outer cylindrical member 220.

The downstream cylindrical member 260 is a cylindrical member having an upstream end portion 261a and a downstream end portion 261b.

It is preferable that an axial direction of the downstream cylindrical member 260 coincides with that of the pillar shaped honeycomb structure 210, and a central axis of the downstream cylindrical member 260 coincides with that of the pillar shaped honeycomb structure 210.

Diameters (outer diameter and inner diameter) of the downstream cylindrical member 260 may be uniform in the axial direction, but at least a part of the diameters may be decreased or increased.

A material of the downstream cylindrical member 260 includes, but not limited to, the same materials as those of the first outer cylindrical member 220 as listed above.

A thickness of the downstream cylindrical member 260 includes, but not limited to, the same thickness as that of the first outer cylindrical member 220 as described above.

### <Second Outer Cylindrical Member 270>

The second outer cylindrical member 270 is arranged on a radially outer side of the first outer cylindrical member 220 at a distance so as to form a flow path for a second fluid.

The second outer cylindrical member 270 is a cylindrical member having an upstream end portion 271a and a downstream end portion 271b.

It is preferable that an axial direction of the second outer cylindrical member 270 coincides with that of the pillar shaped honeycomb structure 210, and a central axis of the second outer cylindrical member 270 coincides with that of the pillar shaped honeycomb structure 210.

The upstream end portion 271a of the second outer cylindrical member 270 preferably extends beyond the position of the first end face 213a of the pillar shaped honeycomb structure 210 to the upstream side. Such a structure can allow a heat recovery efficiency to be improved.

The second outer cylindrical member 270 is preferably connected to both a feed pipe 272 for feeding the second fluid to a region between the second outer cylindrical member 270 and the first outer cylindrical member 220, and a discharge pipe 273 for discharging the second fluid from a region between the second outer cylindrical member 270 and the first outer cylindrical member 220. The feed pipe 272 and the discharge pipe 273 are preferably provided at positions corresponding to both axial ends of the pillar shaped honeycomb structure 210, respectively.

The feed pipe 272 and the discharge pipe 273 may extend in the same direction, or may extend in different directions.

The second outer cylindrical member 270 is preferably arranged such that inner peripheral surfaces of the upstream end portion 271a and the downstream end portion 271b are in direct or indirect contact with the outer peripheral surface of the first outer cylindrical member 220.

A method of fixing the inner peripheral surfaces of the upstream end portion 271a and the downstream end portion 271b of the second outer cylindrical member 270 to the outer peripheral surface of the first outer cylindrical member 220 that can be used herein includes, but not limited to, fitting such as clearance fitting, interference fitting and shrinkage fitting, as well as brazing, welding, diffusion bonding, and the like.

Diameters (outer diameter and inner diameter) of the second outer cylindrical member 270 may be uniform in the axial direction, but the diameter of at least a part (for example, a central portion in the axial direction, both ends in the axial direction, or the like) of the second outer cylindrical member 270 may be decreased or increased. For example, by decreasing the diameter of the central portion in the axial direction of the second outer cylindrical member 270, the second fluid can spread throughout the outer peripheral direction of the first outer cylindrical member 220 in the second outer cylindrical member 270 on the feed pipe 272 and discharge pipe 273 sides. Therefore, an amount of the second fluid that does not contribute to the heat exchange at the central portion in the axial direction is reduced, so that the heat exchange efficiency can be improved.

A material of the second outer cylindrical member 270 includes, but not limited to, the same materials as those of the first outer cylindrical member 220 as listed above.

A thickness of the second outer cylindrical member 270 includes, but not limited to, the same thickness as that of the first outer cylindrical member 220 as described above.

### <First Fluid and Second Fluid>

The first fluid and the second fluid used in the heat exchanger 200 are not particularly limited, and various liquids and gases can be used. For example, when the heat exchanger 200 is mounted on a motor vehicle, an exhaust gas can be used as the first fluid, and water or antifreeze (LLC defined by JIS K2234: 2006) can be used as the second fluid. Further, the first fluid can be a fluid having a temperature higher than that of the second fluid.

### <Method for Producing Heat Exchanger 200>

The heat exchanger 200 can be produced in accordance with a method known in the art. For example, the heat exchanger 200 can be produced in accordance with the method as described below.

First, a green body containing ceramic powder is extruded into a desired shape to prepare a honeycomb formed body. At this time, the shape and density of the cells 214, and lengths and thicknesses of the partition wall 215, the inner peripheral wall 211 and the outer peripheral wall 212, and the like, can be controlled by selecting dies and jigs in appropriate forms. The material of the honeycomb formed body that can be used herein includes the ceramics as described above. For example, when producing a honeycomb formed body containing the Si-impregnated SiC composite as a main component, a binder and water or an organic solvent are added to a predetermined amount of SiC powder, and the resulting mixture is kneaded to form a green body, which can be then formed into a honeycomb formed body having a desired shape. The resulting honeycomb formed body can be then dried, and the honeycomb formed body can be impregnated with metal Si and fired under reduced pressure in an inert gas or vacuum to obtain a hollow pillar shaped honeycomb structure 210 having the cells 214 defined by the partition wall 215. The impregnating and firing of metal Si include arranging a lump containing the metal Si and the honeycomb formed body such that they are contacted with each other, and firing them. The contacted point of the lump containing the metal Si in the honeycomb formed body may be the end face, the surface of the outer peripheral wall 212, or the surface of the inner peripheral wall 211.

The hollow pillar shaped honeycomb structure 210 is then inserted into the first outer cylindrical member 220, and the first outer cylindrical member 220 is fitted to the surface of the outer peripheral wall 212 of the hollow pillar shaped honeycomb structure 210. Subsequently, the inner cylindrical member 230 is inserted into the hollow region of the hollow pillar shaped honeycomb structure 210 and the inner cylindrical member 230 is fitted to the surface of the inner peripheral wall 211 of the hollow pillar shaped honeycomb structure 210. The second outer cylindrical member 270 is then arranged on and fixed to the radially outer side of the first outer cylindrical member 220. The feed pipe 272 and the discharge pipe 273 may be previously fixed to the second outer cylindrical member 270, but they may be fixed to the second outer cylindrical member 270 at an appropriate stage. Next, the upstream cylindrical member 240 is arranged on the radially inner side of the inner cylindrical member 230, and the upstream end portion 221a of the first outer cylindrical member 220 and the upstream side of the upstream cylindrical member 240 are connected to each other via the cylindrical connecting member 250. The downstream cylindrical member 260 is then disposed at and connected to the downstream end portion 221b of the first outer cylindrical member 220. The butterfly valve 100 is then attached onto the downstream end portion 231b side of the inner cylindrical member 230.

In addition, the arranging and fixing (fitting) orders of the respective members are not limited to the above orders, and they may be changed as needed within a range in which the members can be produced. As the fixing (fitting) method, the above method may be used.

### DESCRIPTION OF REFERENCE NUMERALS

10 pipe
15 stopper portion
100 butterfly valve
110 valve plate
111a, 111b plate surface
112 outer peripheral surface
113 groove portion
114 transition portion
115 first plate
115a, 115b plate surface
115c outer peripheral surface
116 second plate
116a, 116b plate surface
116c outer peripheral surface
117 third plate
118 stepped portion
120 shaft
130 valve plate auxiliary member
131 extending portion
132 notch
210 pillar shaped honeycomb structure
211 inner peripheral wall
212 outer peripheral wall
213a first end face
213b second end face
214 cell
215 partition wall
220 first outer cylindrical member
221a upstream end portion
221b downstream end portion
230 inner cylindrical member
231a upstream end portion
231b downstream end portion
232 taper portion
235 through hole
240 upstream cylindrical member
241a upstream end portion
241b downstream end portion
250 cylindrical connecting member
260 downstream cylindrical member
261a upstream end portion
261b downstream end portion
270 second outer cylindrical member
271a upstream end portion
271b downstream end portion
272 feed pipe
273 discharge pipe
280 bearing
290 seal member

1. A butterfly valve provided in a flow path for a first fluid flowing through a heat exchanger, comprising:
a valve plate provided in the flow path;
a shaft for rotatably supporting the valve plate in the flow path; and
at least one valve plate auxiliary member in contact with at least one plate surface of the valve plate, the valve plate auxiliary member having an extending portion extending radially outwardly from an outer peripheral surface of the valve plate;
wherein the valve plate auxiliary member is made of a material having a lower Young's modulus than that of the valve plate.

2. The butterfly valve according to claim 1, wherein the valve plate auxiliary member has a ring shape having an inner diameter smaller than an outer diameter of the valve plate, and having an outer diameter larger than the outer diameter of the valve plate and smaller than an inner diameter of the flow path.

3. The butterfly valve according to claim 2, wherein the valve plate auxiliary member has a halved ring shape wherein the ring shape is divided into halves.

4. The butterfly valve according to claim 3, wherein the halved ring shape has at least one notch formed on the inner diameter side.

5. The butterfly valve according to claim 1, wherein the valve plate auxiliary member comprises two or more valve plate auxiliary member pieces that are not in contact with each other.

6. The butterfly valve according to claim 1, wherein, when the valve plate is divided into two regions A and B by a bisector passing through a central axis of the valve plate, the valve plate auxiliary member is in contact with one plate surface of the valve plate in the region A, and with the other plate surface of the valve plate in the region B.

7. The butterfly valve according to claim 1, wherein the valve plate has at least one groove portion on an outer peripheral surface of the valve plate, and at least a part of the valve plate auxiliary member is arranged in the groove portion.

8. The butterfly valve according to claim 7, wherein the valve plate has a three-layer structure wherein a third plate having a smaller diameter than a first plate and a second plate is sandwiched between the first plate and the second plate.

9. The butterfly valve according to claim 8, wherein the valve plate auxiliary member has a structure that is in contact with both plate surfaces and an outer peripheral surface(s) of the first plate and/or the second plate.

10. The butterfly valve according to claim 1, wherein the valve plate comprises a first plate and a second plate, and at least a part of the valve plate auxiliary member is arranged between the first plate and the second plate.

11. The butterfly valve according to claim 10, wherein the valve plate auxiliary member has a structure that is contact with both plate surfaces and an outer peripheral surface(s) of the first plate and/or the second plate.

12. The butterfly valve according to claim 1, wherein an inner peripheral portion of the flow path for the first fluid has at least one stopper portion contactable with the valve plate and/or the valve plate auxiliary member.

13. A heat exchanger comprising the butterfly valve according to claim 1.

14. The heat exchanger according to claim 13, further comprising:
a hollow pillar shaped honeycomb structure having an outer peripheral wall, an inner peripheral wall, and a partition wall disposed between the outer peripheral wall and the inner peripheral wall, the partition wall defining a plurality of cells, each of the cells extending from a first end face to a second end face to form a flow path for a first fluid; and
an inner cylindrical member fitted to a surface of the inner peripheral wall of the pillar shaped honeycomb structure;
wherein the butterfly valve is provided on a downstream end portion side of the inner cylindrical member.

15. The heat exchanger according to claim 14, further comprising:
a first outer cylindrical member fitted to a surface of the outer peripheral wall of the pillar shaped honeycomb structure;
an upstream cylindrical member having a portion arranged on a radially inner side of the inner cylindrical member at a distance so as to form a flow path for the first fluid;
a cylindrical connecting member for connecting an upstream end portion of the first outer cylindrical member to an upstream side of the inner cylindrical member;
a downstream cylindrical member connected to a downstream end portion of the first outer cylindrical member, the downstream cylindrical portion having a portion arranged on a radially outer side of the inner cylindrical member at a distance so as to form a flow path for the first fluid; and
a second outer cylindrical member arranged on a radially outer side of the first outer cylinder member at a distance so as to form a flow path for a second fluid,
wherein the inner cylindrical member has at least one through hole through which the first fluid flowing through the flow path between the inner cylindrical member and the upstream cylindrical member can be introduced into the pillar shaped honeycomb structure.
